(19) United States
(12) Patent Application Publication
(10) Pub. No.: US 2025/0005632 A1
(43) Pub. Date: Jan. 2, 2025

(54) IN VEHICLE VOICE FEEDBACK

(71) Applicant: FORD GLOBAL TECHNOLOGIES, LLC, Dearborn, MI (US)

(72) Inventors: Jason GRIFFIN, Novi, MI (US); Timothy John WITTROCK, Novi, MI (US); Nicholas FRAZIER, Ann Arbor, MI (US); Katherine BARBER, Northville, MI (US); Kenneth McCAFFREY, Canton, MI (US); Rees WILLIAMS, Lake Orion, MI (US)

(21) Appl. No.: 18/344,961

(22) Filed: Jun. 30, 2023

(51) Int. Cl. G06Q 30/0282

(52) U.S. Cl. CPC G06Q 30/0282

(57) ABSTRACT

A cloud server receives customer feedback from a vehicle, the received customer feedback including voice data and vehicle data, the voice data including speech recorded by the vehicle from an occupant of the vehicle, the vehicle data including a snapshot of information descriptive of operation of the vehicle. The vehicle data is binned into a category of a hierarchy of categories based on textual content of the speech in the voice data. The received customer feedback is added to maintained customer feedback. A portal application presents a user interface to allow the client device to explore the hierarchy of categories and view the maintained customer feedback filtered to a selected one of the hierarchy of categories.

### TECHNICAL FIELD

Aspects of the present disclosure generally relate to in-vehicle voice feedback (IVVF).

### BACKGROUND

Cellular vehicle-to-everything (C-V2X) allows vehicles to exchange information with other vehicles, as well as with infrastructure, pedestrians, networks, and other devices. Vehicle-to-infrastructure (V2I) communication enables applications to facilitate and speed up communication or transactions between vehicles and infrastructure. In a vehicle telematics system, a telematics control unit (TCU) may be used for various remote-control services, such as over the air (OTA) software download, eCall, and turn-by-turn navigation.

### SUMMARY

In one or more illustrative examples, a system for IVVF includes a storage comprising of maintained customer feedback; and a cloud server configured to receive customer feedback from a vehicle, the received customer feedback including voice data and vehicle data, the voice data including speech recorded by the vehicle from an occupant of the vehicle, the vehicle data including a snapshot of information descriptive of operation of the vehicle. The cloud server is further configured to bin the vehicle data into a category of a hierarchy of categories based on textual content of the speech in the voice data, add the received customer feedback to the maintained customer feedback of the storage, and present a portal application to a client device, the portal application presenting a user interface to allow the client device to explore the hierarchy of categories and view the maintained customer feedback filtered to a selected one of the hierarchy of categories.

In one or more illustrative examples, a method for IVVF, includes receiving, to a cloud server, customer feedback from a vehicle, the received customer feedback including voice data and vehicle data, the voice data including speech recorded by the vehicle from an occupant of the vehicle, the vehicle data including a snapshot of information descriptive of operation of the vehicle; binning the vehicle data into a category of a hierarchy of categories based on textual content of the speech in the voice data; adding the received customer feedback to maintained customer feedback; and presenting a portal application to a client device, the portal application presenting a user interface to allow the client device to explore the hierarchy of categories and view the maintained customer feedback filtered to a selected one of the hierarchy of categories.

In one or more illustrative examples, a non-transitory computer readable medium comprising instructions for IVVF that, when executed by one or more computing devices, cause the one or more computing devices to perform operations including to receive customer feedback from a vehicle, the received customer feedback including voice data and vehicle data, the voice data including speech recorded by the vehicle from an occupant of the vehicle, the vehicle data including a snapshot of information descriptive of operation of the vehicle, bin the vehicle data into a category of a hierarchy of categories based on textual content of the speech in the voice data, add the received customer feedback to maintained customer feedback of a storage, and present a portal application to a client device, the portal application presenting a user interface to allow the client device to explore the hierarchy of categories and view the maintained customer feedback filtered to a selected one of the hierarchy of categories.

### BRIEF DESCRIPTION OF THE DRAWINGS

FIG. 1 illustrates an example system for the acquisition and analysis of in-vehicle customer feedback;

FIG. 2A illustrates an example of the human machine interface (HMI) displaying a prompt ready to receive voice data for providing in-vehicle customer feedback;

FIG. 2B illustrates an example of the HMI displaying the prompt during recording of the voice data;

FIG. 3 illustrates an example data flow of the operation of the cloud server in processing customer feedback;

FIG. 4A illustrate an example user interface provided by the portal application for use by the client devices in exploring the hierarchy of categories of the customer feedback;

FIG. 4B illustrates the user interface of the breakdown of a second category within the selected entry of the first category selected in FIG. 4A;

FIG. 4C illustrates the user interface of the breakdown of a third category within the selected entry of the second category selected in FIG. 4B;

FIG. 4D illustrates the user interface of the breakdown of a fourth category within the selected entry of the third category selected in FIG. 4C;

FIG. 5 illustrates a sample of underlying data records within a selected category of the hierarchy being browsed in FIGS. 4A-4D;

FIG. 6 illustrates an example of a closed-loop feedback message for sending to the customer responsive to the customer feedback;

FIG. 7 illustrates an example process for the acquisition of customer feedback from vehicles to provide to the cloud server;

FIG. 8 illustrates an example process for the analysis of the customer feedback by the cloud server; and

FIG. 9 illustrates an example of a computing device for use in the acquisition and analysis of in-vehicle customer feedback.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

There are limitations to current methods of obtaining customer feedback on vehicles. Surveys are only sent to a small fraction of the population via email or post, leaving most customers with no easy method to communicate simple likes, dislikes, or suggestions, apart from contacting a dealership or relationship center. Only 6% of surveys are returned, causing issues with reaching enough samples to have statistically relevant data. Also, traditional surveys are expensive, inefficient, and have a considerable feedback delay.

Email and postal surveys also cannot adequately capture feedback in the heat of the moment. Instead, customers are forced to think back and try to recall their issues when they receive a survey three, twelve, or thirty-six months later, resulting in only top of mind feedback, potentially missing the day-to-day little issues that annoy customers. Thus, valuable information is being missed that manufacturers could use to iterate on products and gain a competitive quality edge.

Using email and postal survey methods, there is currently no way of connecting the survey verbatim (the words from the customer) to something that may be happening within the vehicle data and software logs at that specific moment in time. Yet, doing so may revolutionize customer feedback as the manufacturer can now review vehicle data and software logs that are sent at the time the voice verbatim is created, greatly contributing to the ability to root cause issues.

In-vehicle microphones may be used to receive spoken voice. Text transcription may be used to convert the audio voice data into plain text. A snapshot of vehicle operation may be captured. The audio and vehicle data may be uploaded from the vehicle to a server. Artificial intelligence/machine learning models may be used to bin the verbatims. Data pipelines may be used to help with data processing and reporting and the ability to obtain the vehicle snapshot data. An HMI may be provided on the vehicle to allow the user to record and send the voice feedback. These aspects may be used to allow the vehicle to provide the customer with a feature to allow for the providing of real-time voice feedback. Further aspects of the disclosure are discussed in detail herein.

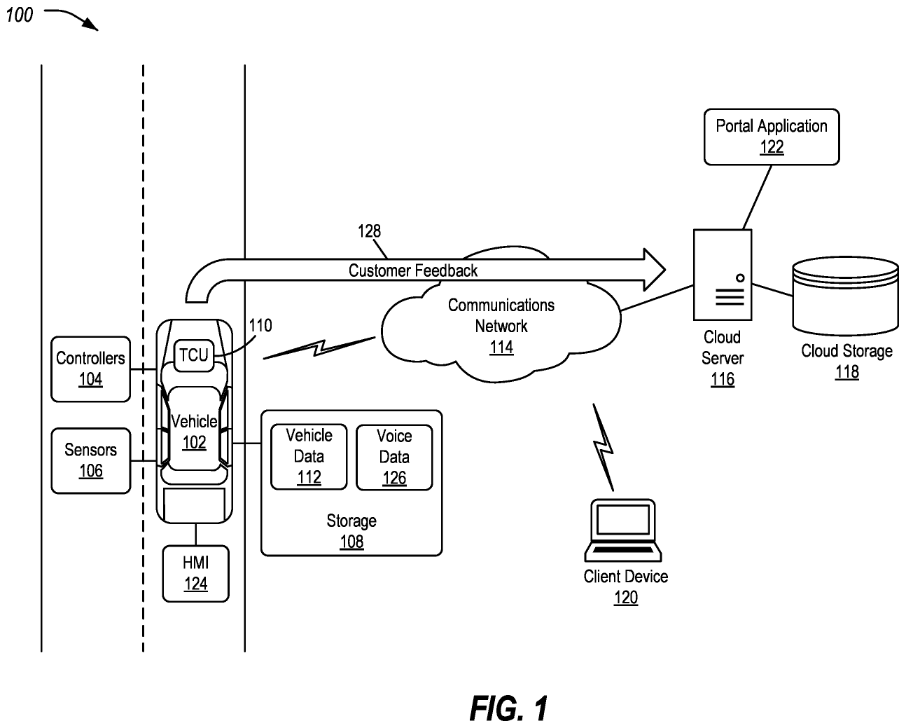

FIG. 1 illustrates an example system 100 for the acquisition and analysis of in-vehicle customer feedback 128. In such a system 100, a vehicle 102 may utilize one or more controllers 104 and sensors 106 to capture vehicle data 112. The vehicle 102 may include a storage 108 configured to maintain the vehicle data 112. The vehicle 102 may also include a TCU 110 configured to communicate over a communications network 114 with a cloud server 116. The cloud server 116 may maintain vehicle data 112 in a cloud storage 118 for use by client devices 120. The vehicle 102 may also include an HMI 124 located within the cabin of the vehicle 102. The HMI 124 may be configured to receive voice data 126 from the occupants of the vehicle 102. Using the vehicle data 112 and the voice data 126, the vehicle 102 may generate customer feedback 128 and send the customer feedback 128 to the cloud server 116 for analysis. It should be noted that the system 100 is only an example, and systems 100 having more, fewer, or different elements may be used. As another example, while only a single cloud server 116 is shown for simplicity, it should be noted that implementations may include multiple cloud components, for load balancing, function separation, or other networking purposes.

The vehicle 102 may include various types of automobile, sedan, crossover utility vehicle (CUV), sport utility vehicle (SUV), truck, recreational vehicle (RV), boat, jeepney, plane or other mobile machine for transporting people or goods. In many cases, the vehicle 102 may be powered by an internal combustion engine. As another possibility, the vehicle 102 may be a battery electric vehicle (BEV) powered by one or more electric motors. As a further possibility, the vehicle 102 may be a hybrid electric vehicle powered by both an internal combustion engine and one or more electric motors, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. Some vehicles 102 may be operator controlled, while other vehicles 102 may be autonomously or semi-autonomously controlled. The vehicle 102 may be identified by various identifiers, such as a vehicle identification number (VIN), which is series of Arabic numbers and Roman letters that is assigned to a motor vehicle for identification purposes. In some cases, the vehicle 102 may be identified by a user account, such as an account linked to a mobile application installed to a mobile device paired with the vehicle 102.

The vehicle 102 may include a plurality of controllers 104 configured to perform and manage various vehicle 102 functions under the power of the vehicle battery and/or drivetrain. In some examples, these controllers 104 may be discrete components. However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller may be configured to provide control of engine operating components (e.g., idle control components, fuel delivery components, emissions control components, etc.) and for monitoring status of such engine operating components (e.g., status of engine codes); a body controller may be configured to manage various power control functions such as exterior lighting, interior lighting, keyless entry, remote start, and point of access status verification (e.g., closure status of the hood, doors and/or trunk of the vehicle 102); a radio transceiver controller may be configured to communicate with key fobs, mobile devices, or other local vehicle 102 devices; an autonomous controller may be configured to provide commands to control the powertrain, steering, or other aspects of the vehicle 102; a climate control management controller may be configured to provide control of heating and cooling system components (e.g., compressor clutch, blower fan, temperature sensors, etc.); and a location controller may be configured to provide global navigation satellite system (GNSS) vehicle location information.

The controllers 104 of the vehicle 102 may make use of various sensors 106 in order to receive information with respect to the surroundings of the vehicle 102. In an example, these sensors 106 may include one or more of cameras (e.g., advanced driver assistance system (ADAS) cameras), ultrasonic sensors, radar systems, and/or lidar systems.

A vehicle bus (not shown) may include various methods of communication available between the vehicle controllers 104, as well as between a TCU 110 and the vehicle controllers 104. As some non-limiting examples, the vehicle bus may include one or more of a vehicle controller area network (CAN), an Ethernet network, and a media-oriented system transfer (MOST) network.

The TCU 110 may be configured to provide telematics services to the vehicle 102. These services may include, as some non-limiting possibilities, navigation, turn-by-turn directions, vehicle health reports, local business search, accident reporting, and hands-free calling. The TCU 110 may accordingly be configured to utilize a transceiver to communicate with a communications network 114.

The TCU 110 may include various types of computing apparatus in support of performance of the functions of the TCU 110 described herein. In an example, the TCU 110 may include one or more processors configured to execute computer instructions, and a storage medium on which the computer-executable instructions and/or data may be maintained. A computer-readable storage medium (also referred to as a processor-readable medium or storage) includes any non-transitory (e.g., tangible) medium that participates in providing data (e.g., instructions) that may be read by a computer (e.g., by the processor(s)). In general, the processor receives instructions and/or data, e.g., from the storage, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, JavaScript, Perl, etc.

The TCU 110 may be configured to facilitate the collection of connected vehicle data 112 and/or other vehicle information from the vehicle controllers 104 connected to the one or more vehicle buses. The vehicle data 112 may include collected information retrieved from the controllers 104 over the vehicle buses. The connected vehicle data 112 may include, as some non-limiting examples, latitude, longitude, time, heading angle, speed, lateral changes in speed, longitudinal changes in speed, yaw rate, throttle position, brake status, steering angle, headlight status, wiper status, external temperature, turn signal status, vehicle length, vehicle width, vehicle mass, and bumper height. The vehicle data 112 may also include weather data (such as ambient temperature, ambient air pressure, etc.), traction control status, wiper status, or other vehicle status information (such as the status of exterior vehicle lights, type of vehicle, antilock brake system (ABS) system status, etc.).

The vehicle data 112 may be stored to a database, memory, or other storage 108 of the vehicle 102. In some cases, the vehicle data 112 may be stored as a snapshot in time. In some cases, the vehicle data 112 may be stored as time series data.

The communications network 114 may provide communications services, such as packet-switched network services (e.g., Internet access, voice over internet protocol (VOIP) communication services), to devices connected to the communications network 114. An example of a communications network 114 is a cellular telephone network. For instance, the TCU 110 may access the cellular network via connection to one or more cellular towers. To facilitate the communications over the communications network 114, the TCU 110 may be associated with unique device identifiers (e.g., mobile device numbers (MDNs), Internet protocol (IP) addresses, etc.) to identify the communications of the TCU 110 on the communications network 114 as being associated with the vehicle 102.

The cloud server 116 may be a computing device configured to communicate with the vehicles 102 over the communications network 114. Similar to the TCU 110, the cloud server 116 may include processors, memory, storage, network connectivity, and/or various peripherals. The cloud server 116 may be configured to receive the vehicle data 112 from the vehicles 102 over the communications network 114. In an example, the vehicle data 112 may be offloaded from the vehicle 102 periodically or based on a vehicle 102 event (e.g., the user sending customer feedback 128). In another example, the vehicle data 112 may be sent by the vehicle 102 responsive to a request by received from the cloud server 116.

The cloud server 116 may include or have access to cloud storage 118. The cloud server 116 may be configured to utilize the cloud storage 118 to maintain data such as the vehicle data 112. The cloud server 116 may be configured to communicate with one or more client devices 120. In an example, the cloud server 116 may be configured to execute a portal application 122 programmed to analyze the vehicle data 112 and provide the client devices 120 with access to the vehicle data 112.

The HMI 124 of the vehicle 102 may be configured to receive user input via various buttons or other controls, as well as provide vehicle status information to a driver, such as fuel level information, engine operating temperature information, and current location of the vehicle 102. The HMI 124 may be configured to provide information to various displays within the vehicle 102, such as a center stack touchscreen, a gauge cluster screen, etc.

The HMI 124 may also include one or more microphones or other audio capture devices. These devices may be used, for example, to convert sound into an audio signal for processing. In an example, the audio signal may be utilized for a hands-free telephone interface. In another example, the audio signal may undergo speech to text processing to be converted into textual data, where the textual data is then processed into commands to be performed by the vehicle 102. This audio signal, in textual or audio signal form, may be referred to herein as voice data 126.

The HMI 124 may also be used to allow the customer to provide real-time voice feedback. This feedback may be recorded by the HMI 124, augmented with a snapshot of the vehicle data 112, and sent to the cloud server 116 as the customer feedback 128.

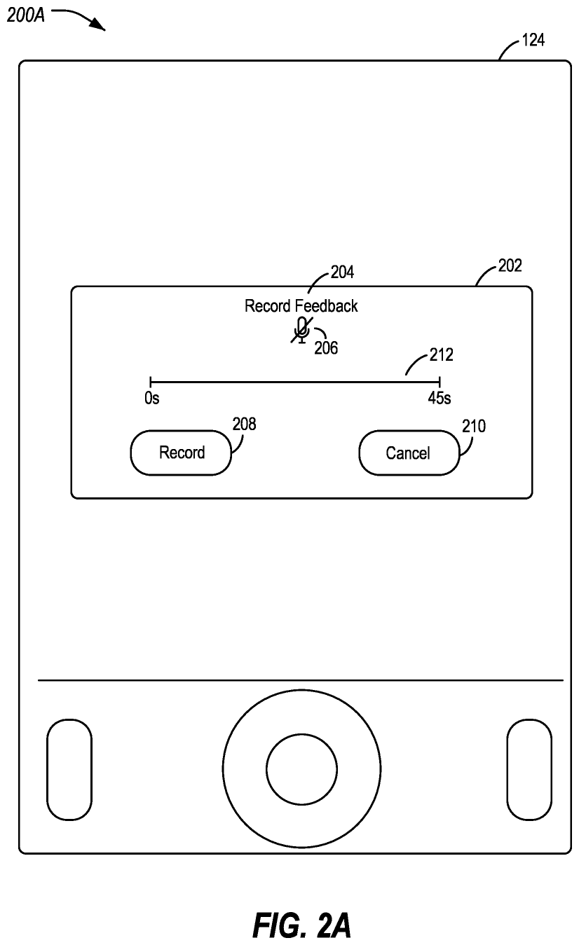

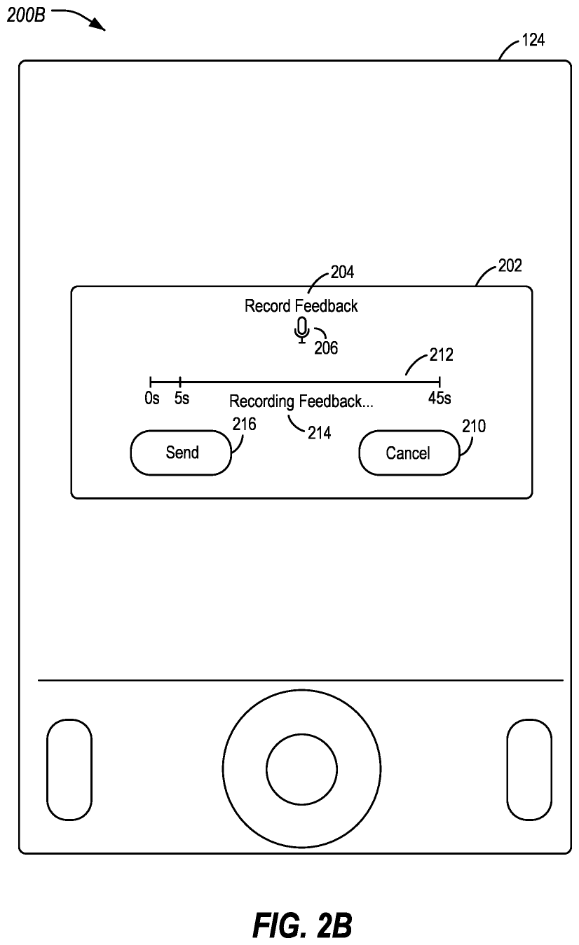

FIG. 2A illustrates an example 200A of the HMI 124 displaying a prompt 202 ready to receive voice data 126 for providing in-vehicle customer feedback 128. FIG. 2B illustrates an example 200B of the HMI 124 displaying the prompt 202 during recording of the voice data 126. As shown, the prompt 202 is displayed on the center stack screen of a vehicle 102. It should be noted that this is only one example, and other locations or designs of prompt 202 are possible.

The prompt 202 may be displayed responsive to selection of a record feedback control in the HMI 124. Or the prompt 202 may be displayed responsive to the user issuing a voice command to the HMI 124 requesting to provide feedback. This feature may be invoked by the customer to allow the customer to provide their thoughts, whether positive or negative, as they occur. For example, the customer may give feedback about a vehicle 102 issue that was just experienced. Or, the customer may give feedback that they were surprised or delighted by a vehicle 102 feature. It should be noted that the customer feedback 128 may be provided while driving, not just when the vehicle 102 is stational, to allow for the capture of customer feedback 128 while the issue is occurring.

The prompt 202 may include a title 204 informing the user that the record feedback function is invoked. The prompt 202 may also include an icon 206 to indicate whether the audio capture device of the HMI 124 is currently active or inactive.

As shown in FIG. 2A, the audio capture device of the HMI 124 is disabled. Additionally, the prompt 202 may include a record control 208 that, when selected, allows the user to record a snippet of audio. The prompt 202 may also include a cancel control 210 that, when selected, allows the user to exit the record feedback function and, e.g., return to the main display of the HMI 124. The prompt 202 may also include a progress bar 212 to indicate the length of the voice data 126 that is captured. As shown, the progress bar 212 indicates a value between zero and forty-five seconds long, but this is only an example and different maximum lengths may be used.

Responsive to selection of the record control 208, the prompt 202 may adjust to the recording form shown in FIG. 2B. As shown in FIG. 2B, once recording is activated the prompt 202 updates to indicate that recording is in progress. For example, the icon 206 may change to indicate that audio capture is enabled. Additionally, the progress bar 212 may show the length of the recorded voice data 126 so far, e.g., five seconds as shown. Also, an indication of recording 214 may be provided, here with the text “Recording Feedback . . . ” but that is only an example. Also, the record control 208 may be replaced with a send control 216.

When selected, the send control 216 causes the vehicle 102 to send the voice data 126 to the cloud server 116. Additionally, the voice data 126 may be sent with a snapshot of the vehicle data 112. This vehicle data 112 snapshot may include information from the controllers 104, software logs, and/or diagnostic test code (DTC) data. By sending the voice data 126 along with the vehicle data 112, the cloud server 116 may receive the feedback in the context of the operation of the vehicle 102. This context may be helpful in determining root cause of issues related to what the customer is saying. For instance, a symptom described by the user may have multiple possible causes, and the vehicle data 112 may be useful in identifying which of the possible causes is the most likely cause. This, in turn, may inform on the correct solution to resolve the issue. If the cancel control 210 is selected, the feedback may be discarded and not sent.

Variations on the prompt 202 are possible. It should be noted that the wording as illustrated is only one possibility, and different wordings may be used, such as “tell us” or “tell [vehicle brand]”. In another example, the capture of the voice data 126 may be triggered by saying a voice command requesting to provide customer feedback 128 responsive to pressing a push-to-talk button, e.g., on the steering wheel. In yet another example, in a vehicle 102 having integration with a voice assistant, a wake word to wake the voice assistant may be spoken by the user with a command requesting to give feedback about the vehicle 102. Or, a phrase may be spoken by the user that indicates that the user does or does not like something about the vehicle 102, e.g., “[wake word], tell Ford I like . . . ” or “don't like.” The voice assistant may then activate the prompt 202.

In yet another example, the prompt 202 may be provided by an app on the user's phone or other mobile device. In such an example, the mobile device may record the voice data 126, receive the vehicle data 112 from the vehicle 102 (e.g., via wired or wireless connection to the telematics system or the onboard diagnostics (OBD-II) port), and provide the customer feedback 128 from the mobile device to the cloud server 116. In an example using a phone application, data from the user's mobile device may be used to augment the verbatim. For instance, the user may use the mobile device to record audio, video, still images, etc., corresponding to the issue being discussed in the verbatim, and the phone application may include that information in the customer feedback 128. It should be noted that for vehicle 102 implementations, image data such as from in-vehicle cameras may also be included in the vehicle data 112 compiled into the customer feedback 128.

In still a further example, the prompt 202 may allow for the user to review the recording before sending. For instance, the prompt 202 may include a control that, when selected, plays back the recorded voice data 126 to allow the user to verify the verbatim before sending.

As another possibility, the prompt 202 may include controls to allow the user to select sentiment related to the verbatim. For instance, the prompt 202 may provide controls to allow the user to select whether the verbatim is positive, negative, or neutral. These controls may be illustrated with happy face, neutral face, and unhappy face emoticons, as one possibility.

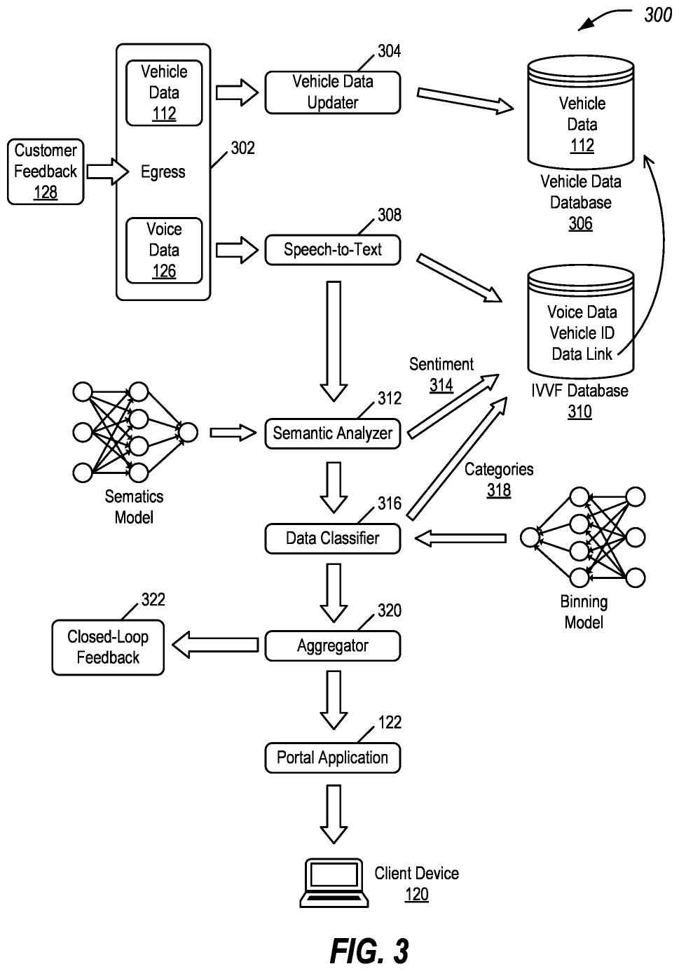

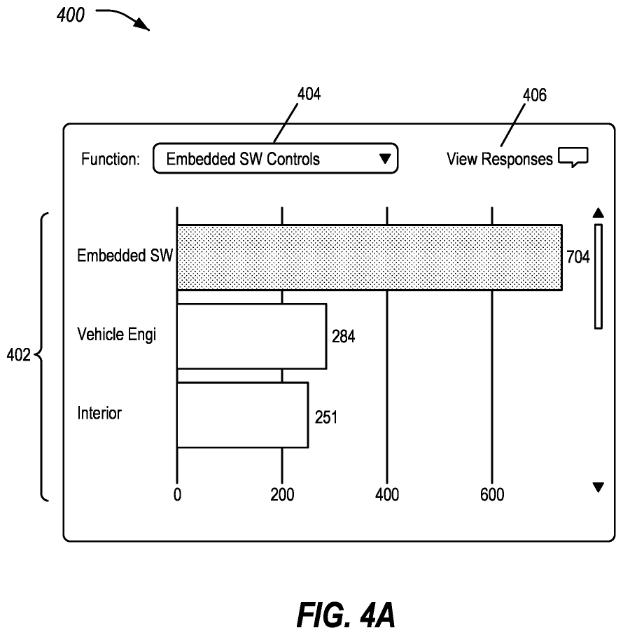

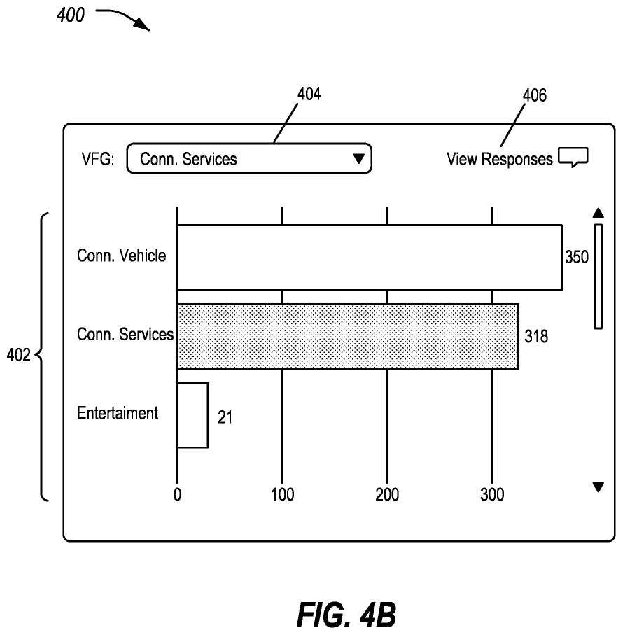

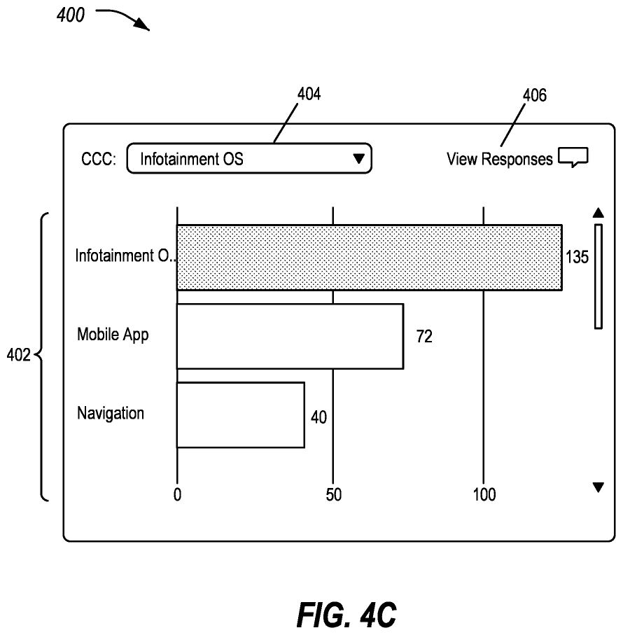

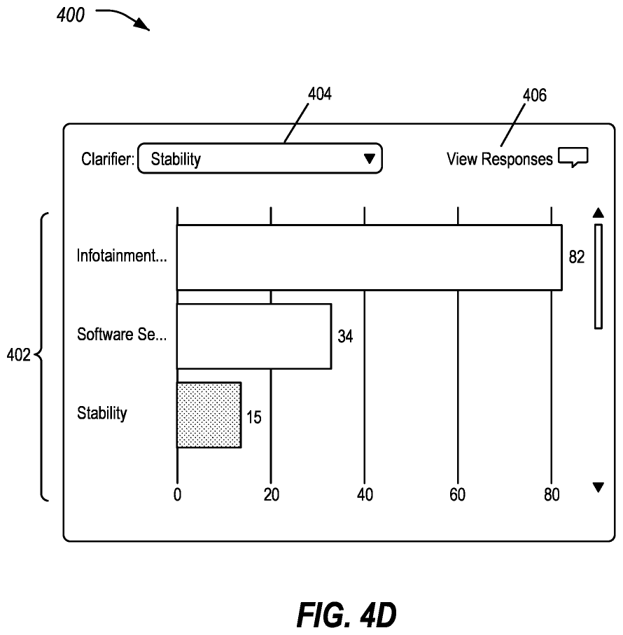

FIG. 3 illustrates an example data flow 300 of the operation of the cloud server 116 in processing the received customer feedback 128. As shown, the cloud server 116 may receive the vehicle data 112 and voice data 126 at an egress component 302. The cloud server 116 may use a vehicle data updater 304 to add the received vehicle data 112 to a vehicle data database 306. The cloud server 116 may also use a speech-to-text component 308 to convert the voice data 126 into textual data for storage into an IVVF database 310. The cloud server 116 may use a semantic analyzer 312 on the voice data 126 to determine sentiment of the feedback and may also use a data classifier 316 to categorize the feedback into one or more categories and/or ontologies of information. Once augmented, the voice data 126 may be provided to an aggregator 320 for analysis and may be made available to the portal application 122 for querying by the client devices 120. Examples of operation of the portal application 122 is shown in FIGS. 4A-6.

The egress component 302 may be configured to receive, validate, and route the vehicle data 112 and the voice data 126. In an example, the egress component 302 may perform checksum verification or other data validations on the received data to ensure that the data was transported without error. The egress component 302 may also retrieve an identifier of the vehicle 102 from the received data, such as the VIN of the vehicle 102. This vehicle identifier may be used to ensure that the sender is set up to use the cloud servers 116. For instance, the egress component 302 may ensure that the vehicle has opted into use of the feedback feature.

The vehicle data updater 304 may be configured to receive the vehicle data 112 from the egress component 302. The vehicle data updater 304 may utilize the vehicle identifier as an index to add the vehicle data 112 into the vehicle data database 306. The vehicle data database 306 may be configured to maintain the vehicle data 112 for various diagnostics purposes.

The speech-to-text component 308 may be configured to transform audio signal data including speech content into textual content. Speech-to-text, also known as automatic speech recognition (ASR), is a technology that converts spoken language into written text. To perform the recognition, the voice data 126 may be preprocessed using noise reduction, filtering, and normalization to remove background noise or disturbances that could affect speech recognition accuracy. The preprocessed audio signal may then be converted into a sequence of acoustic features. Commonly used features include Mel-frequency cepstral coefficients (MFCCs), which represent the spectral characteristics of the audio signal over time. An acoustic modeler may be used to maps the extracted acoustic features to phonetic units or sub-word units. Additional language modeling or word boundary post-processing may also be performed to improve the quality of the results. It should be noted that while the data flow 300 shows the speech-to-text being performed by the cloud server 116, this may be performed on the vehicle 102 side in other examples.

The IVVF database 310 may be a data store configured to maintain the voice data 126, receive additional attributes of the voice data 126, and allow the voice data 126 to be available for analysis. The IVVF database 310 may include records that include the voice data 126 in text form, the voice data 126 in audio form, the vehicle 102 identifier corresponding to the voice data 126, the time of capture of the voice data 126, and a data link for each record of the voice data 126 to the corresponding vehicle data 112 stored in the vehicle data database 306.

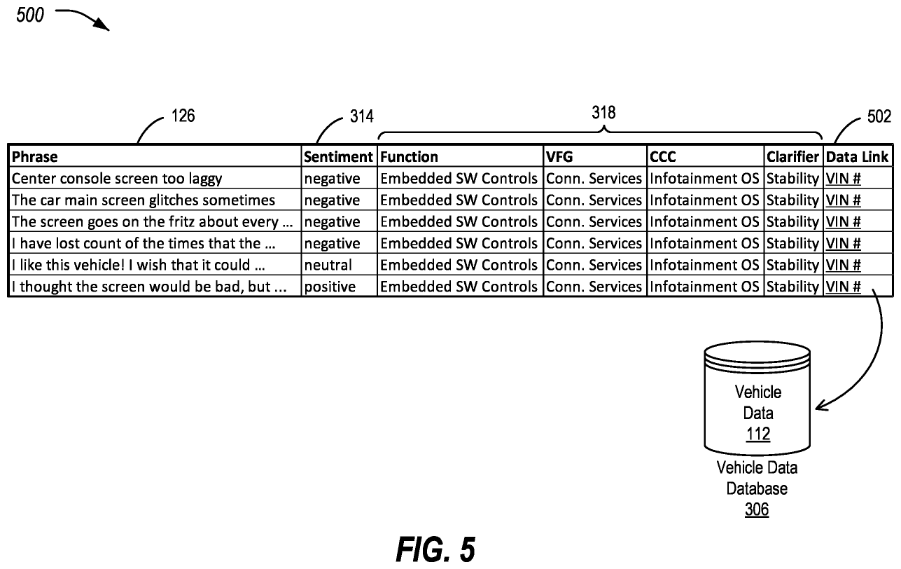

The semantic analyzer 312 may utilize sentiment analysis or opinion mining techniques used to determine the sentiment 314 or emotion expressed in a piece of text. The output of the semantic analyzer 312 may indicate wither the text is positive, negative, or neutral overall. To perform the recognition, the voice data 126 may be preprocessed to remove content that does not carry much sentiment 314, such as most common words. Various techniques may then be used to represent the text in a form where relevant features are extracted to capture sentiment 314 signals. This information may then be applied to a model trained based on labeled data to classify text into various sentiments, such as positive, negative, neutral, or different emotional states such as happy, sad, angry. This sentiment 314 information may be added to the voice data 126 as attributes of the voice data 126 (as shown in FIG. 5).

The data classifier 316 categorizes the voice data 126 into different bins or categories 318 based on its content using a variety of techniques and approaches. In one example, keywords may be used to represent the categories 318, and presence or frequency of these keywords in the text may be used to assign the text to the correct category 318. Or a rule-based classification may use a set of predefined rules to categorize speech based on the included terms. Or, verbs in the test may be used as keywords to perform the binning. Or, a machine learning model may be trained using labeled training data including text and the associated category 318, where the model is used in an inference mode to assign the text to the category 318. In some examples, the data classifier 316 may use multiple different sets of bins or categories 318 to categorize the text, such as a categorization of vehicle functions, a categorization of issue categories 318, etc. This bin information may also be added to the voice data 126 as category 318 attributes of the voice data 126 (as shown in FIG. 5).

In one specific example, the voice data 126 may be binned into a hierarchy of categories 318, starting with a first bin of vehicle function, and within those bins vehicle function group (VFG), followed by customer concern code (CCC), and then followed by clarifier. The vehicle function may indicate the relevant feature of the vehicle such as interior, exterior, underbody, driver assistant, paint, telematics system, heating, ventilation, and air conditioning (HVAC), etc. The VFG refers to a code for component classification used in quality binning of issues. The CCC reflects a sub-code under the VFG at a more granular level of the hierarchy. The clarifier refers to a classification of specific issues or issue types.

The aggregator 320 may be configured to receive and combine the voice data 126 as augmented with sentiment 314 and categories 318. For example, the aggregator 320 may process data corresponding to voice data 126 received over a predefined period of time, or for all time in the system 100, and may generate records that indicate the frequency of occurrence of the categories 318, sentiments 314, and/or other factors to be considered. Thus, the voice data 126 is now annotated with information that may be used by the portal application 122 in categorizing and reviewing the customer feedback 128. The portal application 122 may utilize the data in the IVVF database 310 as processed by the aggregator 320 to provide an interface for use by the client devices 120.

FIGS. 4A-4B collectively illustrate an example user interface provided by the portal application 122 for use by the client devices 120 in exploring the hierarchy of categories 318 of the customer feedback 128. In an example, a client device 120 may access the portal application 122 of the cloud server 116 over the communications network 114. In another example, the portal application 122 may only be made available through an internal network, not over the communications network 114 at large. In one example, the portal application 122 is a web application, while in another example the portal application 122 is a thick-client dedicated application for use in accessing the portal application 122.

As shown in FIG. 4A, the user interface 400 shows a data visualization 402 of the customer feedback 128 in the top level function category 318, a dropdown control 404 for selecting a specific category 318 (i.e., a subcategory) from the available categories 318, and a view responses control 406 that, when selected, allows the user to view the underlying data records 500 stored in the IVVF database 310.

The data visualization 402 may illustrate the quantities of customer feedback 128 records that are classified into each of the categories 318 by the data classifier 316. This example data visualization 402 provides the information as a scrollable bar graph sorted from largest to smallest, with the quantity of records indicated by each bar, but this is only one example of a possible data visualization 402. In the specific example of user interface 400, the Embedded Software Controls category 318 is selected in the dropdown control 404. This is also illustrated by the corresponding highlighting of that same category 318 in the data visualization 402.

FIG. 4B illustrates the user interface 400 of the breakdown of a second category 318 within the selected entry of the first category 318. For example, responsive to selection of the Embedded Software Controls category 318 in FIG. 4A, the breakdown of that category 318 into subcategories is now shown.

FIG. 4C illustrates the user interface 400 of the breakdown of a third category 318 within the selected entry of the second category 318. For example, responsive to selection of the Connected Services category 318 in FIG. 4B, the breakdown of that category 318 into subcategories is now shown.

FIG. 4D illustrates the user interface 400 of the breakdown of a fourth category 318 within the selected entry of the third category 318. For example, responsive to selection of the Infotainment Operating System category 318 in FIG. 4C, the breakdown of that category 318 into subcategories is now shown.

FIG. 5 illustrates a sample of underlying data records 500 within a selected category 318 of the hierarchy being browsed in FIGS. 4A-4D. In the illustrated example, underlying data records 500 stored in the IVVF database 310 are shown that are filtered according to the selected of the first, second, third, and fourth categories 318 described above. For instance, the underlying data records 500 may be displayed responsive to user selection of the view responses control 406 from the user interface 400 shown in FIG. 4D. However, it should be noted that the underlying data records 500 may be available to be viewed at any level of the categories 318 by selecting the view responses control 406.

As shown, the data records 500 may include various rows of data, including the voice data 126, the sentiment 314, the categories 318, and a link 502 to the voice data 126 stored in the vehicle data database 306. These data elements may allow the user to review the actual customer feedback 128 received from the customers. By traversing the link 502 to the vehicle data database 306, the user may be able to view the recorded snapshot of the operation of the vehicle 102 to aid in understanding the root cause for the customer feedback 128.

Additionally, the customer feedback 128 may be used to implement closed-loop feedback (CLF). In an example, the data classifier 316 or another component along the data flow 300 may flag voice data 126 that includes specific terms, categories 318, and/or sentiments 314 for following up back to the customer.

Referring back to FIG. 3, responsive to detection of such customer feedback 128, a closed-loop feedback component 322 of the cloud server 116 may attempt to connect back with the customer. In an example, the closed-loop feedback component 322 may access the vehicle data database 306 to identify contact information for the consumer that is associated with the vehicle identifier of the vehicle 102 providing the customer feedback 128. This contact information may include an email address or a phone number, as some examples.

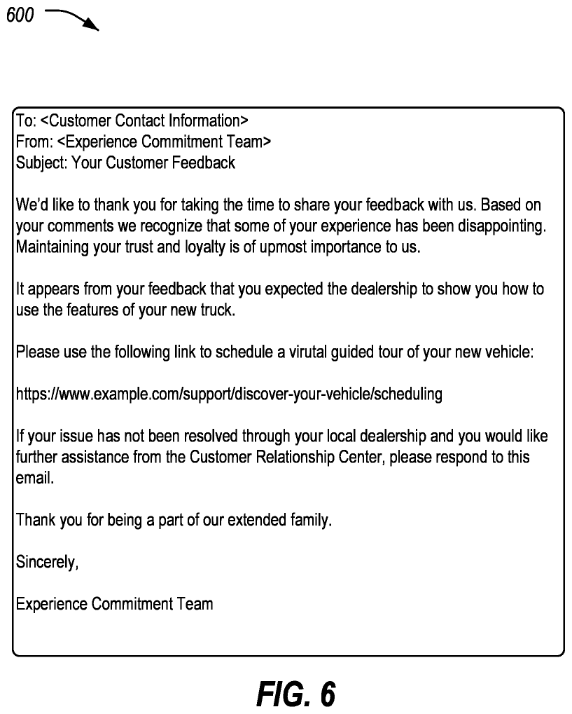

FIG. 6 illustrates an example of a closed-loop feedback message 600 for sending to the customer responsive to the customer feedback 128. As shown, the example closed-loop feedback message 600 is an email message to the contact information associated with the vehicle 102 having provided the customer feedback 128.

For example, the customer feedback 128 may have indicated that the dealership experience was not optimal, and that nobody at the dealership showed the customer how to use the features of a truck that the customer had purchased. Responsive to the wording and sentiment 314 in the customer feedback 128, the cloud server 116 may bin the customer feedback 128 into a category 318 of dealership experience, and a subcategory of vehicle walkthrough.

Based on the customer feedback 128 being in that categorization, the closed-loop feedback component 322 may automatically respond with the feedback message 600. Based on the categorization of the issue, the closed-loop feedback component 322 may look up and include, in the feedback message 600, an associated proposed resolution to the issue. Here, the proposed resolution is a virtual guided tour, but this is only an example. It should also be noted that more advanced techniques than using the binning to provide the suggestion may be possible. For instance,

Additionally, the closed-loop feedback component 322 may further include, in the CLF message 600, an indication that the customer may reply to the message to receive further assistance. If the customer replies to the message, then the cloud server 116 may automatically open a support record in a customer support system. This support record may link to the voice data 126 and vehicle data 112 from the customer feedback 128 and may be assigned to a customer support technician for analysis. To associate the response with the customer feedback 128, the cloud server 116 may recognize an identifier included in the message to recognize the specific customer feedback 128. As some examples, this may include the customer contact information, an identifier embedded in the message text, a specific email address from which the CLF message 600 is sent associated with the customer feedback 128, etc. Thus, the in-vehicle customer feedback 128 may further be used to close the loop on the customer feedback 128 and expedite resolution of the customer issue.

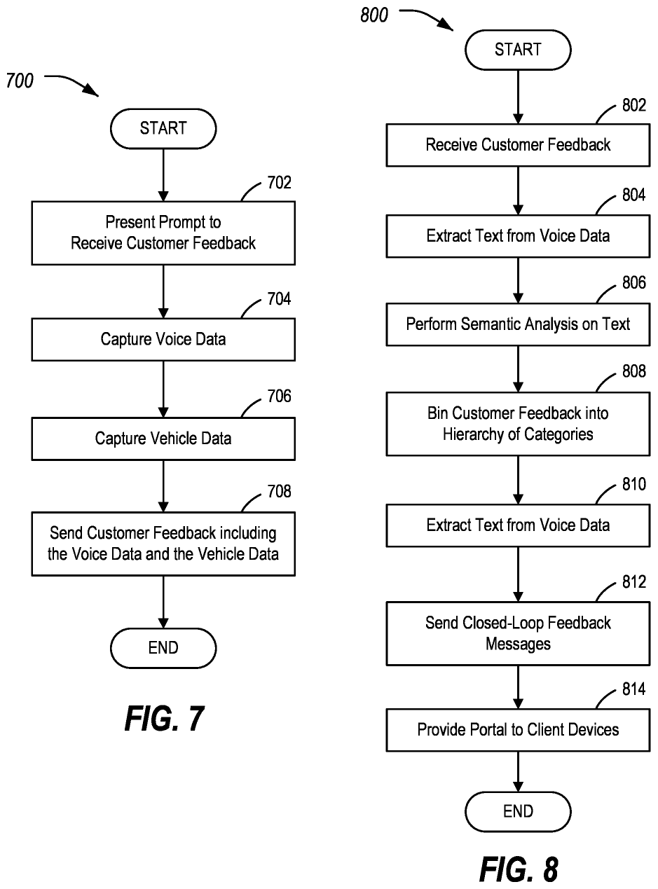

FIG. 7 illustrates an example process 700 for the acquisition of customer feedback 128 from vehicles 102 to provide to the cloud server 116. In an example, the process 700 may be performed by the HMI 124, TCU 110, and other components of the vehicles 102 of the system 100.

At operation 702, the vehicle 102 presents the prompt 202 to receive customer feedback 128. The prompt 202 may be displayed responsive to selection of a record feedback control in the HMI 124. Or the prompt 202 may be displayed responsive to the user issuing a voice command to the HMI 124 requesting to provide feedback. This feature may be invoked by the customer to allow the customer to provide their thoughts, whether positive or negative, as they occur. For example, the customer may give feedback about a vehicle 102 issue that was just experienced. Or, the customer may give feedback that they were surprised or delighted by a vehicle 102 feature. An example prompt 202 is illustrated in FIGS. 2A-2B.

At operation 704, the vehicle 102 captures voice data 126. The prompt 202 may include a record control 208 that, when selected, allows the user to record a snippet of audio. Responsive to selection of the record control 208, the prompt 202 may utilize the audio capture device of the HMI 124 to receive the voice data 126.

At operation 706, the vehicle 102 captures vehicle data 112. This vehicle data 112 snapshot may include information from the controllers 104, software logs, and/or DTC data. In some examples, this vehicle data 112 is captured by the TCU 110 (or another controller 104) in due course to be available in case the data is needed. In other example, the vehicle data 112 is captured responsive to the capture of the voice data 126. For instance, the capture may be initiated responsive to activation of the prompt 202 and/or responsive to selection of the record control 208.

At operation 708, the vehicle 102 sends the customer feedback 128 including the voice data 126 and the vehicle data 112 to the cloud server 116. When selected, the send control 216 of the prompt 202 causes the vehicle 102 to send the voice data 126 captured at operation 704 and the vehicle data 112 captured at operation 706 to the cloud server 116. By sending the voice data 126 along with the vehicle data 112, the cloud server 116 may receive the feedback in the context of the operation of the vehicle 102. This context may be helpful in determining root cause of issues related to what the customer is saying. After operation 708, the process 700 ends.

FIG. 8 illustrates an example process 800 for the analysis of the customer feedback 128. In an example the process 800 may be performed by the cloud server 116 in the context of the system 100.

At operation 802, the cloud server 116 receives customer feedback 128. The customer feedback 128 may include voice data 126 and vehicle data 112. For instance, the cloud server 116 may receive the vehicle data 112 and voice data 126 at an egress component 302. The voice data 126 may include speech recorded by the vehicle 102 from an occupant of the vehicle 102. The vehicle data 112 may include a snapshot of information descriptive of operation 702 of the vehicle 102. In an example 200A the customer feedback 128 may have been sent by the vehicle 102 as discussed with respect to operation 708 in the context of the process 700.

At operation 804, the cloud server 116 extracts text from the customer feedback 128. In an example, the cloud server 116 may also use a speech-to-text component 308 to convert the voice data 126 into textual data for storage into an IVVF database 310. In another example, the vehicle 102 may have performed the speech-to-text conversion and the extraction may include reading the textual data out of the received customer feedback 128.

At operation 806, the cloud server 116 performs semantic analysis on the text. The semantic analyzer 312 may utilize sentiment analysis or opinion mining techniques used to determine the sentiment 314 or emotion expressed in a piece of text. The output of the semantic analyzer 312 may indicate wither the text is positive, negative, or neutral overall. This sentiment 314 information may be added to the voice data 126 as attributes of the voice data 126.

At operation 808, the cloud server 116 bins the customer feedback 128 into a hierarchy of categories 318. In an example, the data classifier 316 may categorize the voice data 126 into different bins or categories 318 based on its content using a variety of techniques and approaches. This bin information may also be added to the voice data 126 as category 318 attributes of the voice data 126. The illustrations of FIGS. 4A-4D and 5 illustrate an example hierarchy of categories 318.

At operation 810, the cloud server 116 stores the customer feedback 128. In an example, the cloud server 116 stores the vehicle data 112 in a vehicle data database 306, and stores the voice data 126 in a IVVF database 310. The cloud server 116 may use a vehicle data updater 304 to add the vehicle data 112 to a vehicle data database 306. The voice data 126 in the IVVF database 310 may be stored with links 502 to the vehicle data 112 in the vehicle data database 306 corresponding to the voice data 126.

At operation 812, the cloud server 116 sends closed-loop feedback messages 600. In an example, the closed-loop feedback component 322 may access the vehicle data database 306 to identify contact information for the consumer that is associated with the vehicle identifier of the vehicle 102 providing the customer feedback 128. This contact information may include an email address or a phone number, as some examples. Based on the categories 318 of the customer feedback 128, the closed-loop feedback component 322 may look up an associated proposed resolution to the customer feedback 128, based on the customer feedback 128 being in that categorization. The closed-loop feedback component 322 may automatically respond with a feedback message 600. The CLF component 322 may further include, in the CLF message 600, an indication that the customer may reply to the message to receive further assistance. If the customer replies to the message, then the cloud server 116 may automatically open a support record in a customer support system. This support record may link to the voice data 126 and vehicle data 112 from the customer feedback 128 and may be assigned to a customer support technician for analysis.

At operation 814, the cloud server 116 provides the portal application 122 to the client devices 120. The portal application 122 may present a user interface 400 to allow the client device 120 to explore the hierarchy of categories 318 and view the maintained customer feedback 128 filtered to a selected one of the hierarchy of categories 318. The portal application 122 may also present, for each voice data 126 record, a link 502 to provide access to the vehicle data 112 in the vehicle data database 306 corresponding to the voice data 126. After operation 814, the process 800 ends.

Variations on the use of the IVVF system 100 are possible. In one variation, the closed loop feedback may be tied into predictive repair intelligence (PRI). For example, before a vehicle 102 arrives for service, the dealership may utilize a client device 120 to access the portal application 122 to pull any customer feedback 128 that was sent from the vehicle 102. This may expedite the diagnosis of issues with the vehicle 102 as well as potentially allow for the ordering of parts in advance of the arrival of the vehicle 102 at the dealership.

In another example, instead of the customer initiating the IVVF, the cloud server 116 may send a request to the user to open the prompt 202 and provide feedback. This request may be displayed in the HMI 124, sent as an email or text or call or other message to the customer, displayed as a news item in a vehicle application installed to the user's mobile device, etc. In an example, the cloud server 116 may send the request to provide customer feedback 128 at predefined milestones. These milestones could include, as some examples, one week after warranty start date, at a set of feedback intervals (e.g., three months, one year, three years), at mileage-based intervals, etc. This customer feedback 128 may also be tracked per-vehicle across the lifecycle of the vehicle 102, to allow for analysis of the same vehicle 102 over time.

In yet another example, the cloud server 116 may send the request to the user to open the prompt 202 and provide feedback responsive to the customer's vehicle 102 being chosen for a specific survey about a vehicle 102 component. For instance, if the original equipment manufacturer (OEM) wishes to gain information about how the customer likes the interior of a vehicle 102 of a particular model or trim, a survey may be sent to corresponding vehicles 102 for response using the prompt 202.

In still another example, the vehicle 102 or cloud server 116 may raise a feedback request to the user responsive to occurrence of a DTC. This may allow the OEM to receive information from a user about what is being experienced by the vehicle 102 when the code was encountered. For instance, customers may opt into a program to provide feedback on severity levels of detected vehicle events to enhance the OEM's understanding of those events on the customer.

As another possibility, the IVVF system 100 may reward the user for providing customer feedback 128. This may provide an incentive for users to provide useful input. In an example, a verification process may be performed by an administrative user of the client device 120 to ensure that the customer feedback 128 is valid or useful. The reward to the user may include, for example, points that can be used off dealer products and services that the user may purchase.

In another example, the IVVF system 100 may support a two-way voice interaction with the user. For instance, responsive to the user submitting the customer feedback 128, the vehicle 102 may ask the user if it is desired to be connected with an agent. If the user agrees, the vehicle 102 may call a support center to initiate a telephone support call. The support center may also receive access to the customer feedback 128 provided by the user, as context for the support call. It should be noted that user may instead be asked if it is desired to be connected to a dealership. Or, instead of an immediate call, the user may be asked if it is desired for a support person or dealership to call the user back. If the user agrees, then a call may be set up to the vehicle 102 or other contact information of the user.

In some examples, the customer feedback 128 may be accessible by the dealership when the vehicle 102 is taken in for service. This may allow the dealership to review whether the user has had issues with the vehicle 102. If so, the dealer may address the issue, such as by making repairs or educating the user on how to better use the vehicle 102.

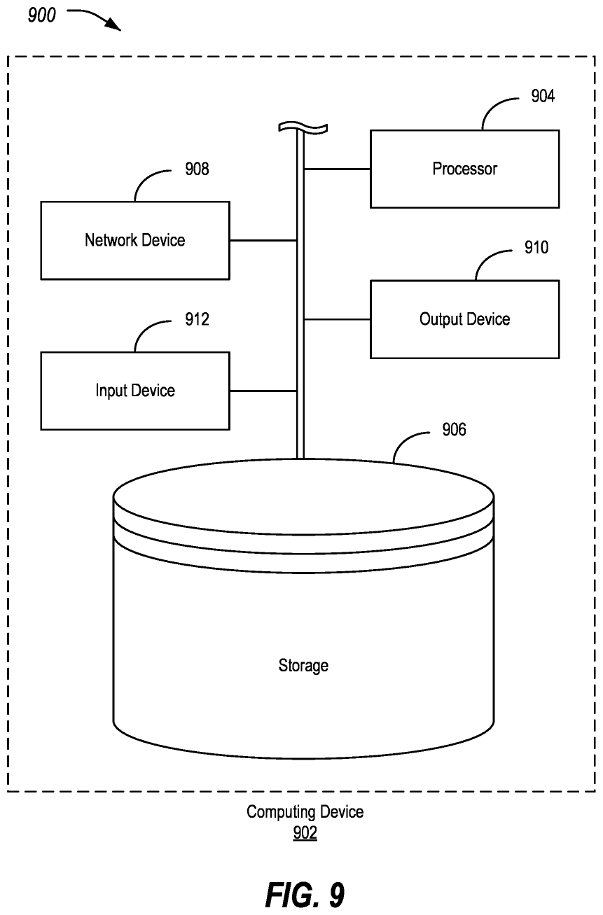

FIG. 9 illustrates an example 900 of a computing device 902 for use in the acquisition and analysis of in-vehicle customer feedback 128. Referring to FIG. 9, and with reference to FIGS. 1-8, the controllers 104, sensors 106, storage 108, TCU 110, communications network 114, cloud server 116, cloud storage 118, client devices 120, and HMI 124, etc., may be examples of such computing devices 902. As shown, the computing device 902 may include a processor 904 that is operatively connected to a storage 906, a network device 908, an output device 910, and an input device 912. It should be noted that this is merely an example, and computing devices 902 with more, fewer, or different components may be used.

The processor 904 may include one or more integrated circuits that implement the functionality of a central processing unit (CPU) and/or graphics processing unit (GPU). In some examples, the processors 904 are a system on a chip (SoC) that integrates the functionality of the CPU and GPU. The SoC may optionally include other components such as, for example, the storage 906 and the network device 908 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stages (MIPS) instruction set families.

Regardless of the specifics, during operation the processor 904 executes stored program instructions that are retrieved from the storage 906. The stored program instructions, such as those of the portal application 122, egress component 302, vehicle data database 306, speech-to-text component 308, semantic analyzer 312, data classifier 316, and aggregator 320, include software that controls the operation of the processors 904 to perform the operations described herein. The storage 906 may include both non-volatile memory and volatile memory devices. The non-volatile memory includes solid-state memories, such as not AND (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100. This data may include, as non-limiting examples, the vehicle data 112, voice data 126, and customer feedback 128.

The GPU may include hardware and software for display of at least two-dimensional (2D) and optionally three-dimensional (3D) graphics to the output device 910. The output device 910 may include a graphical or visual display device, such as an electronic display screen, projector, printer, or any other suitable device that reproduces a graphical display. As another example, the output device 910 may include an audio device, such as a loudspeaker or headphone. As yet a further example, the output device 910 may include a tactile device, such as a mechanically raiseable device that may, in an example, be configured to display braille or another physical output that may be touched to provide information to a user.

The input device 912 may include any of various devices that enable the computing device 902 to receive control input from users. Examples of suitable input devices that receive human interface inputs may include keyboards, mice, trackballs, touchscreens, voice input devices, graphics tablets, and the like.

The network devices 908 may each include any of various devices that enable the devices discussed herein to send and/or receive data from external devices over networks. Examples of suitable network devices 908 include an Ethernet interface, a Wi-Fi transceiver, a Li-Fi transceiver, a cellular transceiver, or a BLUETOOTH or BLUETOOTH low energy (BLE) transceiver, or other network adapter or peripheral interconnection device that receives data from another computer or external data storage device, which can be useful for receiving large sets of data in an efficient manner.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for in-vehicle voice feedback (IVVF), comprising:
a storage comprising maintained customer feedback; and
a cloud server configured to:
receive customer feedback from a vehicle, the received customer feedback including voice data and vehicle data, the voice data including speech recorded by the vehicle from an occupant of the vehicle, the vehicle data including a snapshot of information descriptive of operation of the vehicle,
bin the vehicle data into a category of a hierarchy of categories based on textual content of the speech in the voice data,
add the received customer feedback to the maintained customer feedback of the storage, and
present a portal application to a client device, the portal application presenting a user interface to allow the client device to explore the hierarchy of categories and view the maintained customer feedback filtered to a selected one of the hierarchy of categories.

2. The system of claim 1, wherein the cloud server is further configured to:
store the vehicle data in a vehicle data database of the storage; and
store the voice data in a IVVF database of the storage,
wherein the voice data in the IVVF database is stored with links to the vehicle data in the vehicle data database corresponding to the voice data.

3. The system of claim 2, wherein the portal application is further configured to present, for each voice data record, a link to provide access to the vehicle data in the vehicle data database corresponding to the voice data.

4. The system of claim 1, wherein the cloud server is further configured to:
utilize a semantic analyzer to identify sentiment in the speech;
augment the voice data to include the identified sentiment; and
present the sentiment in the portal application along with the maintained customer feedback.

5. The system of claim 1, wherein the cloud server is further configured to bin the voice data according to keywords, verbs, or phrases included in the voice data.

6. The system of claim 1, wherein the cloud server is further configured to:
identify a potential solution for an issue indicated by the maintained customer feedback based on the category that the voice data is binned into the hierarchy of categories; and
send a message to contact information corresponding to the maintained customer feedback, the message indicating the potential solution.

7. The system of claim 6, wherein the cloud server is further configured to:
responsive to the cloud server receiving a reply to the message, automatically open a support record linked to the voice data and the vehicle data of the received customer feedback for analysis.

8. The system of claim 6, wherein the cloud server is further configured to utilize the vehicle data to identify a root cause for the issue.

9. A method for in-vehicle voice feedback (IVVF), comprising:
receiving, to a cloud server, customer feedback from a vehicle, the received customer feedback including voice data and vehicle data, the voice data including speech recorded by the vehicle from an occupant of the vehicle, the vehicle data including a snapshot of information descriptive of operation of the vehicle;
binning the vehicle data into a category of a hierarchy of categories based on textual content of the speech in the voice data;
adding the received customer feedback to maintained customer feedback; and
presenting a portal application to a client device, the portal application presenting a user interface to allow the client device to explore the hierarchy of categories and view the maintained customer feedback filtered to a selected one of the hierarchy of categories.

10. The method of claim 9, further comprising:
storing the vehicle data in a vehicle data database; and
storing the voice data in a IVVF database,
wherein the voice data in the IVVF database is stored with links to the vehicle data in the vehicle data database corresponding to the voice data.

11. The method of claim 10, further comprising presenting, for each voice data record, a link to provide access to the vehicle data in the vehicle data database corresponding to the voice data.

12. The method of claim 9, further comprising:
utilizing a semantic analyzer to identify sentiment in the speech;
augmenting the voice data to include the identified sentiment; and
presenting the sentiment in the portal application along with the maintained customer feedback.

13. The method of claim 9, further comprising binning the voice data according to keywords, verbs, or phrases included in the voice data.

14. The method of claim 9, further comprising:
identifying a potential solution for an issue indicated by the maintained customer feedback based on the category that the voice data is binned into the hierarchy of categories; and
sending a message to contact information corresponding to the maintained customer feedback, the message indicating the potential solution.

15. The method of claim 14, further comprising:
responsive to receiving a reply to the message, opening a support record linked to the voice data and the vehicle data of the received customer feedback for analysis.

16. The method of claim 14, further comprising utilizing the vehicle data to identify a root cause for the issue.

17. The method of claim 9, further comprising:
presenting, via a human machine interface (HMI) of the vehicle, a prompt for receiving the voice data for the received customer feedback;
receiving the voice data from the occupant of the vehicle;
capturing the snapshot of information descriptive of the operation of the vehicle; and
sending, from the vehicle to the cloud server, the received customer feedback including the voice data and the snapshot.

18. A non-transitory computer readable medium comprising instructions for in-vehicle voice feedback (IVVF) that, when executed by one or more computing devices, cause the one or more computing devices to perform operations including to:
receive customer feedback from a vehicle, the received customer feedback including voice data and vehicle data, the voice data including speech recorded by the vehicle from an occupant of the vehicle, the vehicle data including a snapshot of information descriptive of operation of the vehicle,
bin the vehicle data into a category of a hierarchy of categories based on textual content of the speech in the corresponding voice data,
add the received customer feedback to maintained customer feedback of a storage, and
present a portal application to a client device, the portal application presenting a user interface to allow the client device to explore the hierarchy of categories and view the maintained customer feedback filtered to a selected one of the hierarchy of categories.

19. The medium of claim 18, further comprising instructions that, when executed by the one or more computing devices, cause the one or more computing devices to perform operations including to:
store the vehicle data in a vehicle data database of the storage; and
store the voice data in a IVVF database of the storage,
wherein the voice data in the IVVF database is stored with links to the vehicle data in the vehicle data database corresponding to the voice data.

20. The medium of claim 19, further comprising instructions that, when executed by the one or more computing devices, cause the one or more computing devices to perform operations including to present, for each voice data record, a link to provide access to the vehicle data in the vehicle data database corresponding to the voice data.

21. The medium of claim 18, further comprising instructions that, when executed by the one or more computing devices, cause the one or more computing devices to perform operations including to:
utilize a semantic analyzer to identify sentiment in the speech;
augment the voice data to include the identified sentiment; and
present the sentiment in the portal application along with the maintained customer feedback.

22. The medium of claim 18, further comprising instructions that, when executed by the one or more computing devices, cause the one or more computing devices to perform operations including to bin the voice data according to keywords, verbs, or phrases included in the voice data.

23. The medium of claim 18, further comprising instructions that, when executed by the one or more computing devices, cause the one or more computing devices to perform operations including to:
identify a potential solution for an issue indicated by the maintained customer feedback based on the category that the voice data is binned into the hierarchy of categories; and
send a message to contact information corresponding to the maintained customer feedback, the message indicating the potential solution.

24. The medium of claim 23, further comprising instructions that, when executed by the one or more computing devices, cause the one or more computing devices to perform operations including to:
responsive to the one or more computing devices receiving a reply to the message, automatically open a support record linked to the voice data and the vehicle data of the received customer feedback for analysis.

25. The medium of claim 23, further comprising instructions that, when executed by the one or more computing devices, cause the one or more computing devices to perform operations including to utilize the vehicle data to identify a root cause for the issue.
